(19) United States
(12) Patent Application Publication
(10) Pub. No.: US 2011/0295760 A1
(43) Pub. Date: Dec. 1, 2011

(54) BENEFITS ENROLMENT IN AN ENTERPRISE

(75) Inventors: Nagaraj Mohan Hunur, Hyderabad (IN); Anoop Sharma, Hyderabad (IN)

(73) Assignee: Oracle International Corporation, Redwood Shores, CA (US)

(21) Appl. No.: 12/789,476

(22) Filed: May 28, 2010

(51) Int. Cl. G06Q 10/00; G06F 3/048

(52) U.S. Cl. 705/322; 715/854

(57) ABSTRACT

Simplifying benefits enrollment in an organization using an enterprise software. A benefits administrator configures plan instances as groups, and the user interface for (enrolling) end users is controlled according to the configuration. The plan instances are displayed as the configured groups, while the user navigates the displayed information to select the specific plans of interest in each displayed group. In an embodiment, each group is presented as a stop in a train, such that the user is forced navigate only successive groups in the train sequence.

### BACKGROUND OF INVENTION

1. Technical Field

The present disclosure relates to application servers used for human capital management, and more specifically to benefits enrolment in an enterprise.

2. Related Art

Enterprises are organizations having a large number (often of the order of several thousands) of employees. Enterprises offer various benefits to employees. These benefits are not for directly aiding execution of the core job the employee is hired for, but rather offered as a part of a total compensation for the employees. Such benefits generally fall in categories such as health, insurance, disability, dental, retirement, etc., as is well known in the relevant arts.

Employees are often required to enroll for specific benefits in an enterprise. Enrollment refers to selection of specific plan instances of interest. Such enrollment is typically necessitated as the employer enterprise may contract with several providers and each provider further providing multiple plan instances in the same plan type. Thus, an employee is generally required to select from many choices of instances, to suit his/her requirements.

There is a general need in the industry to simplify such enrolment.

### BRIEF DESCRIPTION OF THE DRAWINGS

Example embodiments of the present invention will be described with reference to the accompanying drawings briefly described below.

FIG. 1 is block diagram illustrating an example computing system in which several aspects of the present invention can be implemented.

FIG. 2 shows the parties involved in the use of an environment in relation to FIG. 1.

FIG. 3 is a flow chart illustrating the manner in which benefits enrollment is facilitated in an enterprise according to an aspect of the present invention.

FIG. 4A depicts a start screen displayed to a benefits administrator to facilitate control of benefits enrollment in an embodiment.

FIG. 4B depicts a screen used by a benefits administrator to search for specific plan instances of interest in an embodiment.

FIG. 4C depicts a screen provided to benefits administrator to manage plan rates/coverage in an embodiment.

FIG. 4D depicts a screen provided to a benefits administrator to manage eligibility criterion for each plan instance in an embodiment.

FIG. 5A depicts a screen provided to a benefits administrator to manage the benefits configuration in an embodiment.

FIG. 5B depicts the screen provided to a benefits administrator to view plan groups in an embodiment.

FIG. 5C depicts the screen provided to a benefits administrator to manage benefits grouping in an embodiment.

FIG. 5D depicts a screen enabling a benefits administrator to manage plan instances in an embodiment.

FIG. 5E depicts the manner in which a benefits administrator can associate a plan instance with a plan type in an embodiment.

FIG. 5F depicts the manner in which a benefits administrator can create a plan instance and also associate the plan instance with a plan type in an embodiment.

FIG. 6A depicts the manner in which a benefits administrator 280 may associate a plan type to a group in an embodiment.

FIG. 6B depicts the manner in which a plan type is associated with a plan group in an embodiment.

FIG. 6C depicts the manner in which a plan type can be created and associated with a plan group in an embodiment.

FIG. 7 depicts the manner in which the grouping information configured earlier can be viewed by a benefits administrator.

FIG. 8 depicts the user interface provided to an end user in an embodiment.

FIG. 9 is a block diagram illustrating the details of a digital processing system in which several aspects of the present invention are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### 1. Overview

An aspect of the present invention simplifies benefits enrollment in an organization using enterprise software. A benefits administrator configures plan instances as groups, and the user interface for (enrolling) end users is controlled according to the configuration. The plan instances are displayed as the configured groups, while the user navigates the displayed information to select the specific plans of interest in each displayed group. In an embodiment, each group is presented as a stop in a train such that the user is forced to navigate only successive groups in the train sequence.

Several aspects of the present invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

### 2. Example Environment

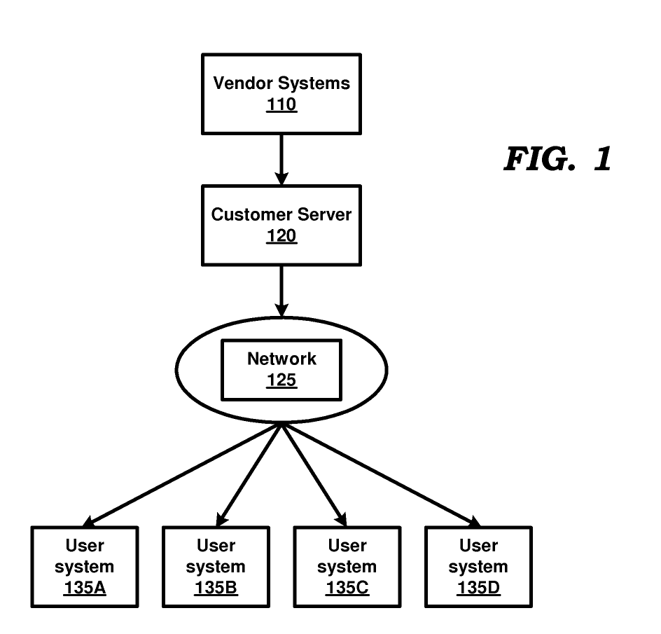

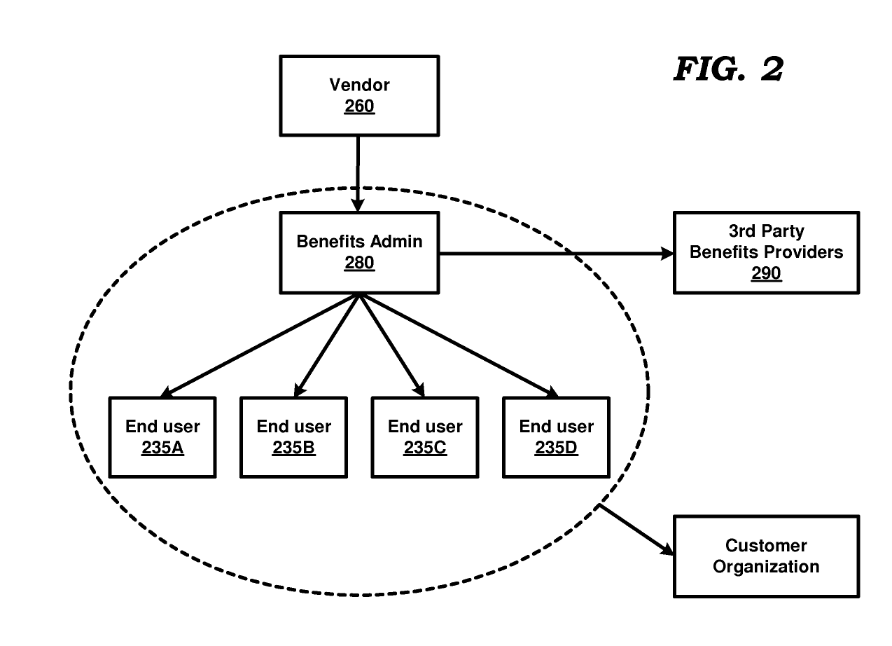

FIG. 1 is block diagram illustrating an example environment in which several aspects of the present invention can be implemented, and FIG. 2 shows the parties involved in the use of such an environment. The block diagram (computing system) is shown containing vendor systems 110, customer server 120, network 125, and user systems 135A-135D. FIG. 2 depicts vendor 260, benefits administrator (admin) 280, 3^{rd} party providers 290, end users 235A-235D in the customer organization (enterprise).

Merely for illustration, only representative number/type of systems is shown in FIGS. 1 and 2. Many environments often contain many more servers, systems, both in number and type, depending on the vendor who uses the invention. Each system/device of FIGS. 1 and 2 is described below in further detail.

Vendor systems 110 represent machines/systems from which vendor 260 provides enterprise software to various customer organizations. Vendor 260 represents organizations such as Oracle Corporation, SAP, Microsoft, who provide enterprise management software to various customer organizations. The software may be provided by way of downloads on Internet or by mediums such as tape drives, etc. It should be understood that the same enterprise software is provided to several customer organizations, though only a single organization is shown in the figures. Each of the customer organizations may use the software as suited in their environment and accordingly configure the software to meet the specific requirements.

Customer server 120 represents a server system (or a cluster of such systems), which is used by a benefits administrator 280 (of a corresponding customer organization) to administer various benefits. Administration entails receiving the enterprise software from vendor systems, configuring the software as suited for the specific environment, enrollment related tasks such as indicating the choices various end users 135A-135D have in terms of benefits and enabling the end users to select choices of interest, etc. The server system 120 may further facilitate tasks such as payments by end users, etc., but (the details of which) are not described herein as not being pertinent to the features described herein.

Network 125 (representing an intranet) provides connectivity between user systems 135A-135D and customer server 120. Network 120 may be implemented using protocols such as Transmission Control Protocol (TCP) and/or Internet Protocol (IP), well known in the relevant arts. Vendor systems 110 may also be connected to customer server 120 using network 125.

Third (3^{rd}) party providers 290 represent organizations such as Aetna, HMO (health maintenance organization), PPO (preferred provider organizations), which provide various benefits options to individual employees of a contracting organization. The benefits administrator may receive information on different 3^{rd} parties, the options each of such parties are offering, and make those choices (along with any employer provided choices, as applicable) available to the end users. The employer may bear some portion of the costs of providing such benefits, while the employees may bear some portion of the cost as well.

End users 235A-235D may be assumed to be employees for whose purpose benefits are sought to be administered in accordance with several features of the present invention. Each end user may use a user system 135A to access the information on customer server 120 to enroll in the benefits programs. The manner in which such enrolment is simplified according to several aspects of the present invention is described below in further detail.

### 3. Flowchart

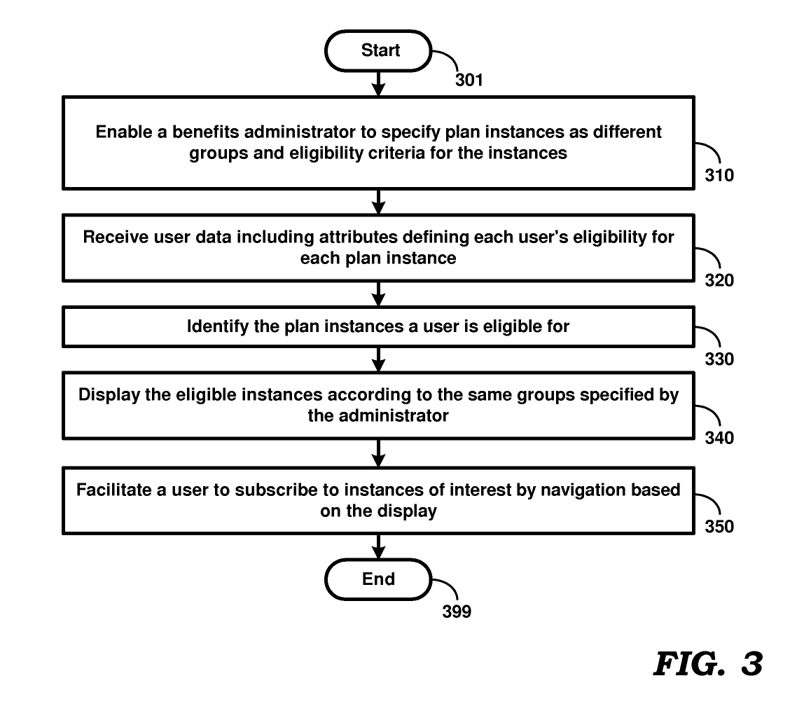

FIG. 3 is a flow chart illustrating the manner in which benefits enrollment is facilitated in an enterprise according to an aspect of the present invention. The flowchart is described for illustration purposes. However, the features of the present invention can be implemented in other environments also without departing from the scope and spirit of several aspects of the current invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. The flow chart begins in step 301, in which control immediately passes to step 310.

In step 310, customer server 120 enables benefits administrator 280 to specify plan instances as different groups and eligibility criteria for the instances. Each plan instance corresponds to an individual plan offered by the third party provider or the employer. Each plan instance is characterized in specifying a corresponding benefit (health, insurance, dental, etc., related) offered by a provider. The eligibility criteria specifies who all can enroll (if there is any restriction based on factors such as designation), cost if any, etc. Grouping implies that the administrator specifies which instances fall in which group.

In step 320, customer server 120 receives user data including attributes defining each user's eligibility for each plan instance. Thus, some attributes indicates information such as a user's designation (manager, vice-president) within the organization, salary, etc. Each attribute is identified by a corresponding identifier (e.g., designation) and has a corresponding associated value for each employee. The values define the employee's eligibility for the plan instance (assuming a plan instance has some specified eligibility criteria).

In step 330, customer server 120 identifies the plan instances a user is eligible for. The eligibility is determined by comparing the user attributes (of step 320) with the eligibility criteria (containing potentially multiple eligibility attributes) specified for the corresponding plan instance. For instance, if an eligibility attribute for a plan instance indicates that only employees of at or below vice-president cadre and having an annual salary of less than 70,000 USD are eligible to enroll, the specific user's designation and salary (user attributes) are respectively compared with the attribute values in the eligibility attributes to determine whether the employee is eligible to enroll in the plan. A set of all such plan instances the user is eligible for, may be determined.

In step 340, customer server 120 displays the eligible instances according to the same groups specified by the administrator. In other words, assuming 10 plan instances were specified as a part of a first group and 8 plan instances were specified as a part of a second group, the eligible ones of the 10 plan instances are displayed as one group and the eligible ones of the 8 plan instances are displayed as another group. Display as a group implies one visually would see the members of that group in close (or otherwise related) localities, while others not in the group would be seen farther (or other conventions which indicates to the general human mind that they are not related). In an embodiment described below, each group is displayed in separate screens/pages of a display. In other words, when one group is displayed, another group is not played on the display screen in such an embodiment.

In step 350, customer server 120 facilitates a user to subscribe to instances of interest by navigation based on the display. Navigation implies that the user can selectively view/display the plans within each group of interest, select the specific displayed plan instances of interest, etc. The flow chart ends in step 399.

Thus, the benefits administrator 280 controls the specific grouping of the plan instances, and each benefits administrator 280 of corresponding organization can configure the grouping according to the requirements suited for their organization. The user interface may accordingly be friendlier for the end users of the corresponding organization. In addition, greater control is provided to the benefits administrator in configuring the enterprise software as suited for the organization requirement.

The features of the flowchart of FIG. 3 can be implemented in various embodiments. The description is continued illustrating the manner in which the steps of FIG. 3 are implemented in one embodiment.

### 4. Example Implementation

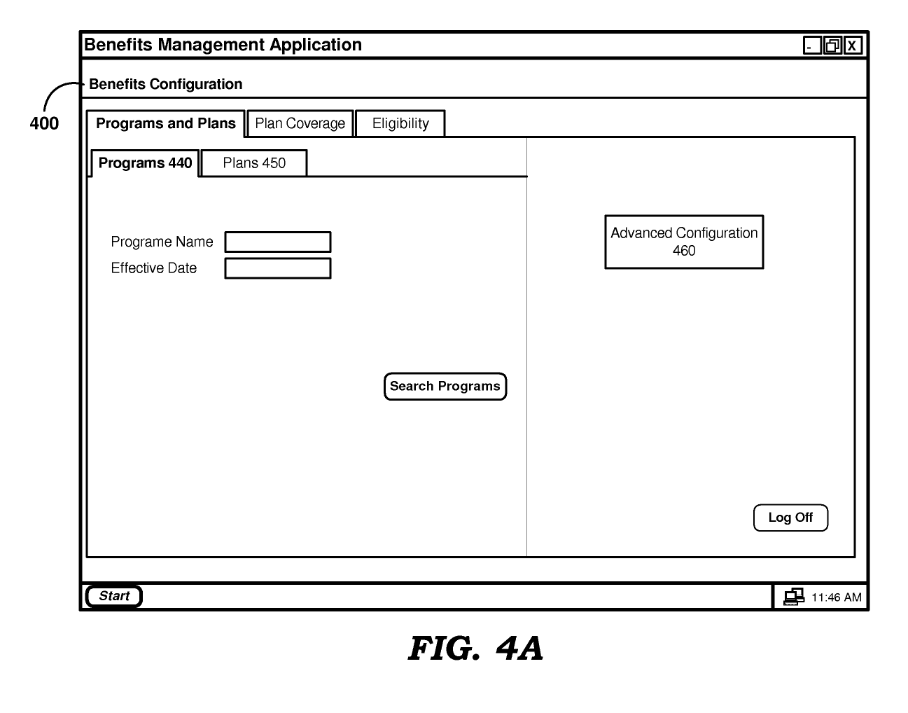

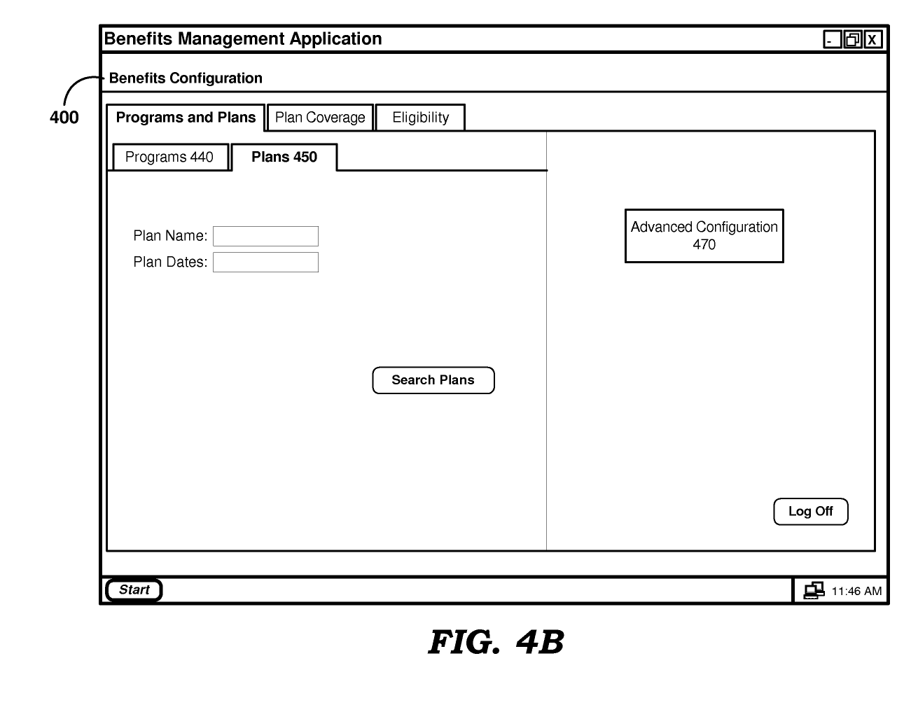

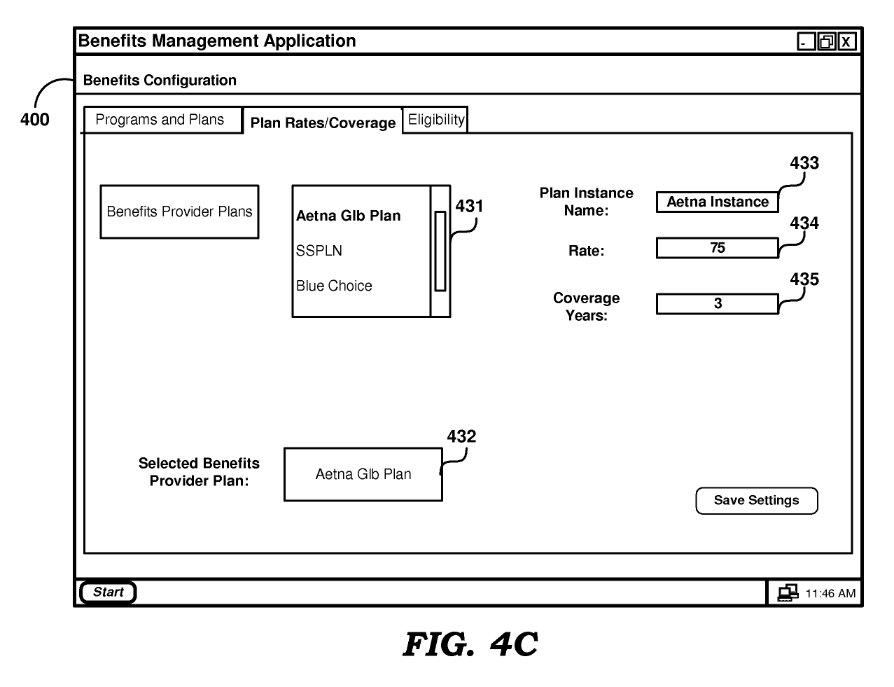

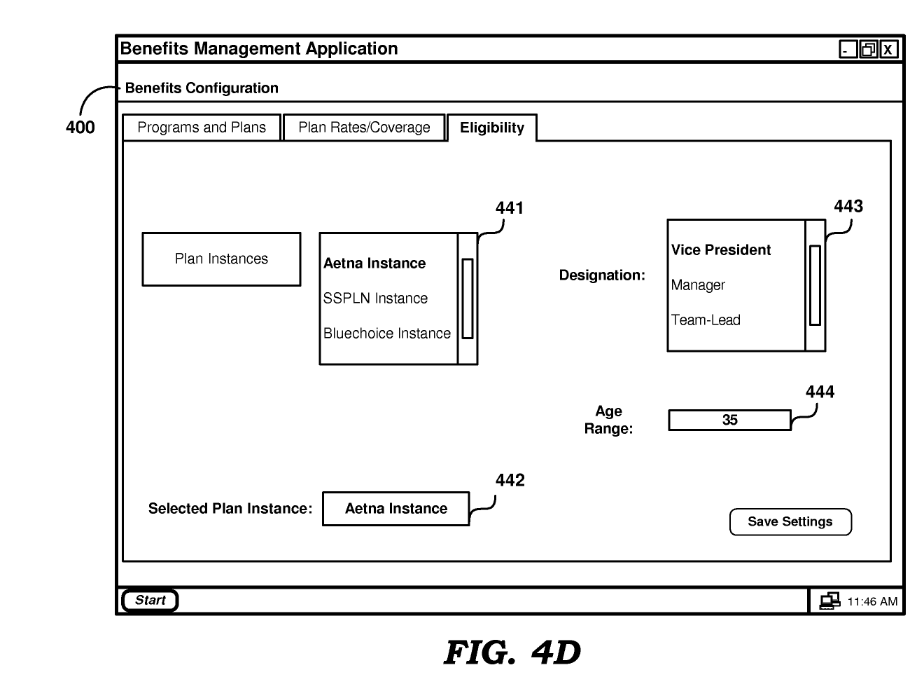

FIG. 4A depicts a start screen displayed to a benefits administrator 280 to facilitate control of benefits enrollment in one embodiment. The administrator may start configuration of various groups (termed as programs) starting by interacting with the display corresponding to programs tab 440. It should be appreciated that each of the displays of FIGS. 4A-9 may correspond to a respective screen displayed in the form of a web page accessed from a corresponding computer system (including customer server 120 or user systems 135A-135D). The administrator can also search for already configured program based on program name and effective date, as shown.

FIG. 4B depicts a display corresponding to plans tab 450 tab and is used by an administrator to search for specific plan instances of interest based on already configured plan instance names or the effective date of the plan instances. A plan instances represents a benefits plan that is eligible for subscription by users.

FIG. 4C depicts screens provided to benefits administrator 280 to manage Plan Rates/Coverage. The various available provider plans (i.e., those provided by 3^{rd} parties providers 290 and any others provided by the organization) are assumed to be already present (based on earlier configuration by the administrator) and displayed there 431. The administrator 280 is shown to have selected a provider plan (432, AETNA GLB Plan), specified the rate 433 and coverage years 434 to form a plan instance, and associated a name (433, Aetna instance) for the plan instance.

Thus, benefits administrator 280 can create multiple instances (from same or different provider plans) and associate a desired name for the particular instance. The changes are made effective by selecting the ‘Save Settings’ on the display area.

FIG. 4D depicts a screen provided to the benefits administrator 280 to manage eligibility criterion for each plan instance. This screen is accessed by selecting the ‘Eligibility’ tab in FIGS. 4A-4C, as shown. Benefits administrator 280 select a plan instance from list 441, and is shown to have selected (442) AETNA instance, configured in FIG. 4C. Two of the eligibility attributes designation 443 and age 444 is shown specified. All the designations (e.g., Vice-president and Team-Lead) of interest may be selected by appropriate user interface. Age groups of 35 and above are shown to be eligible at 444. The changes are made effective by selecting the ‘Save Settings’ on the display area.

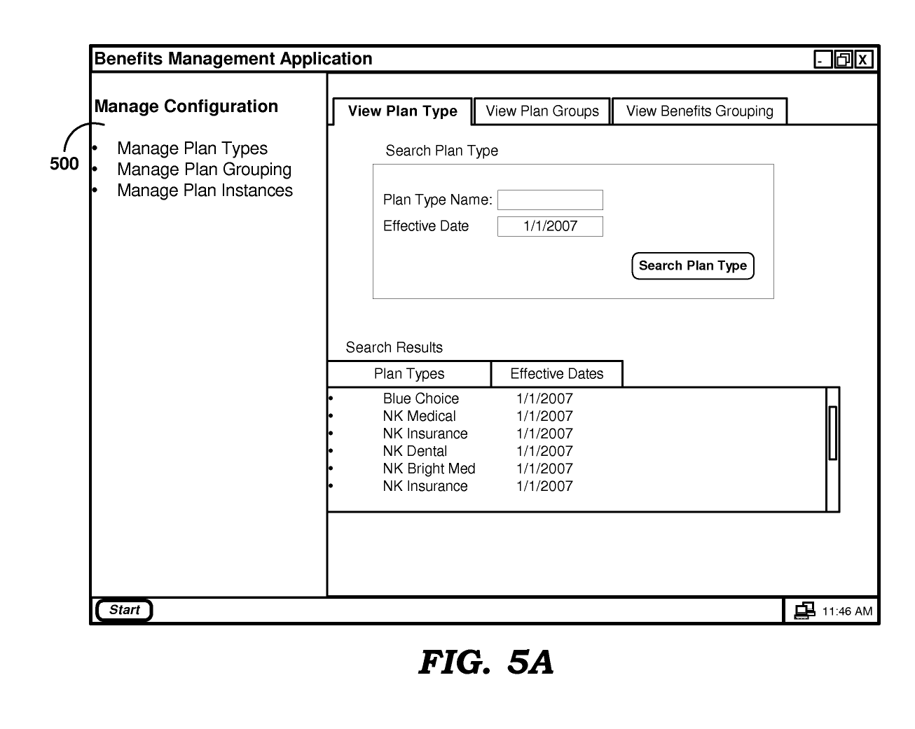

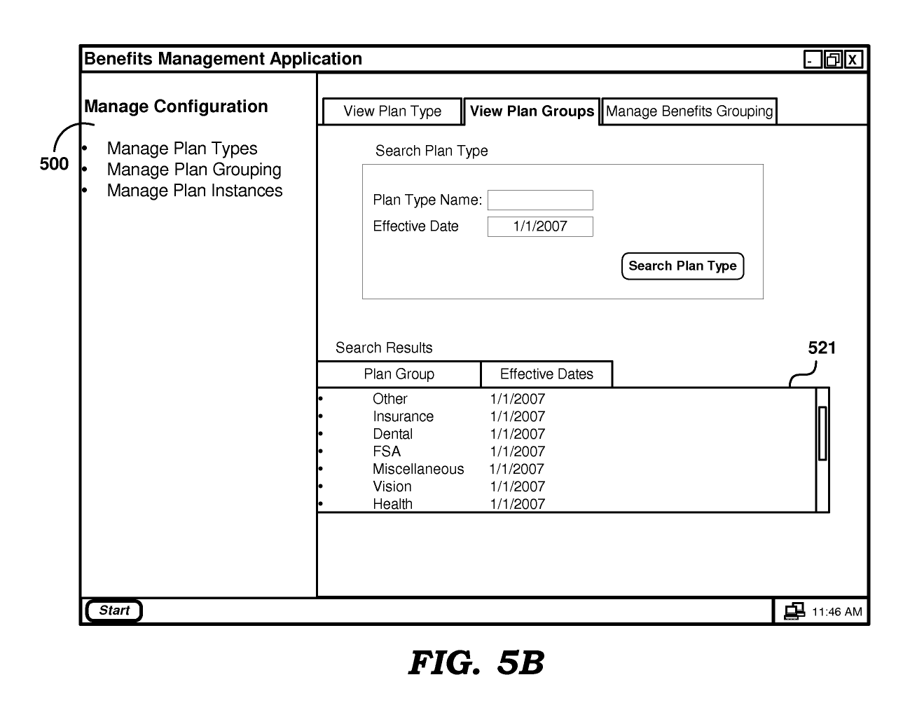

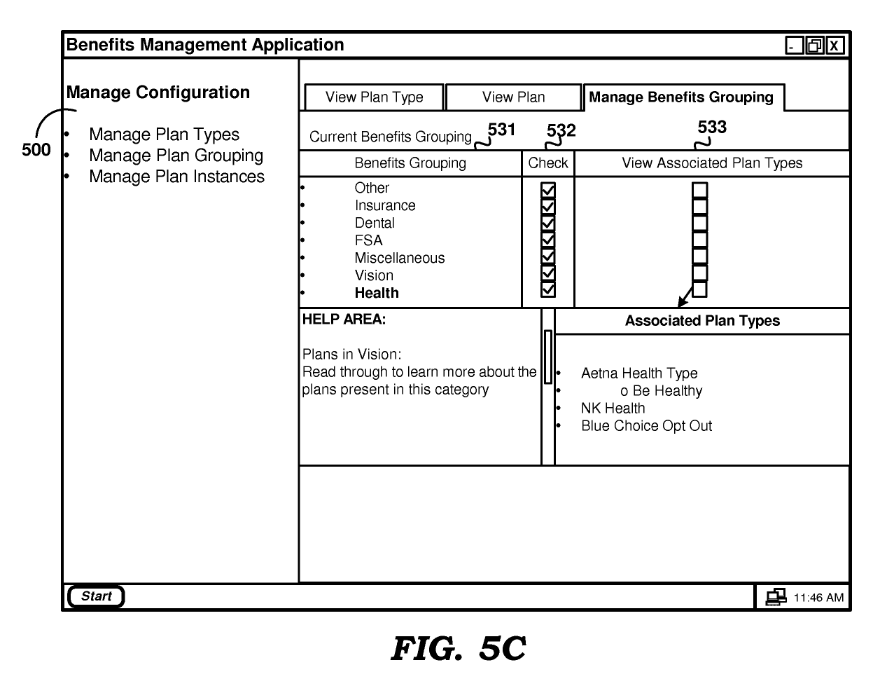

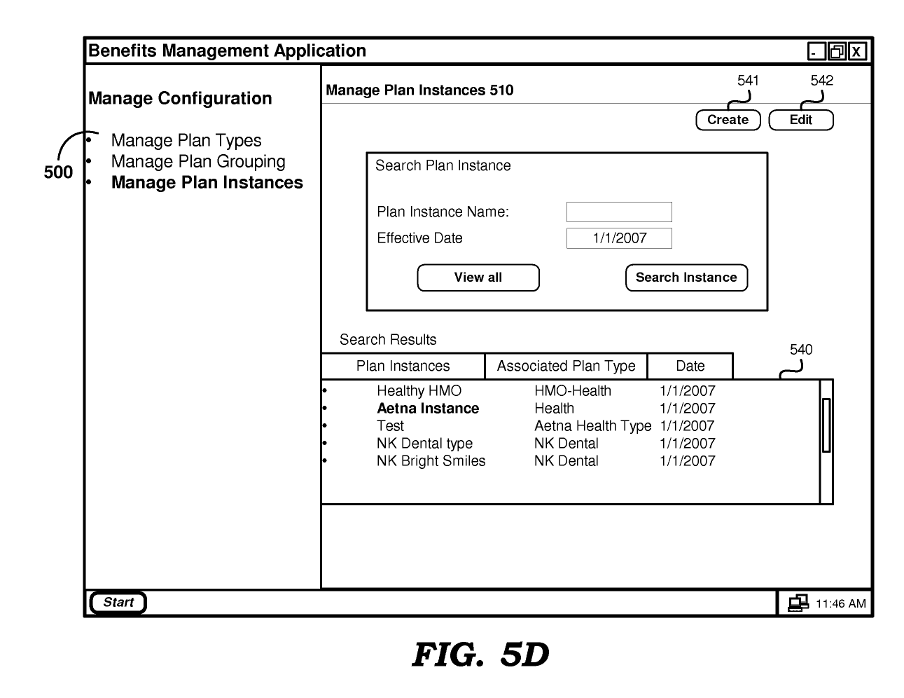

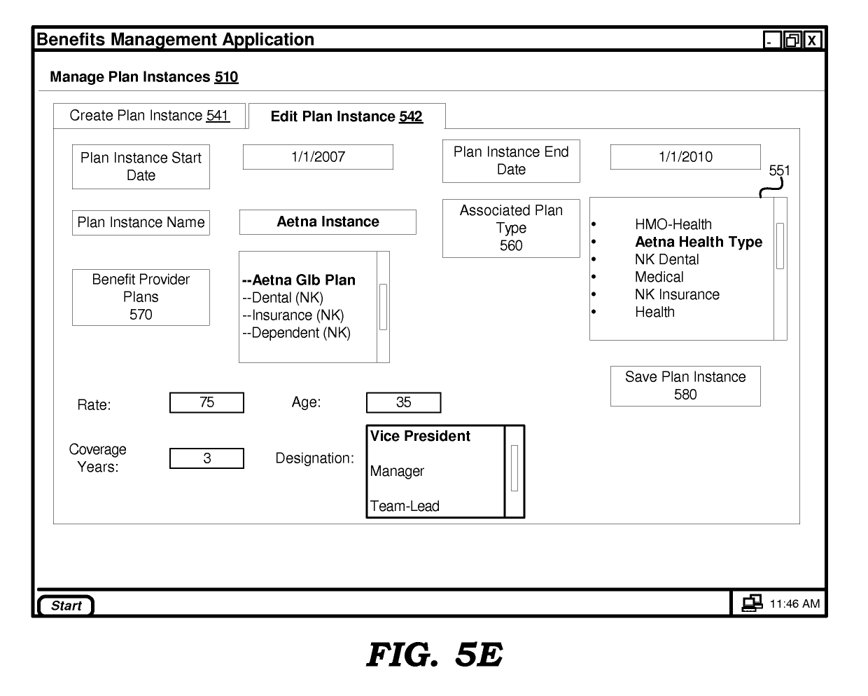

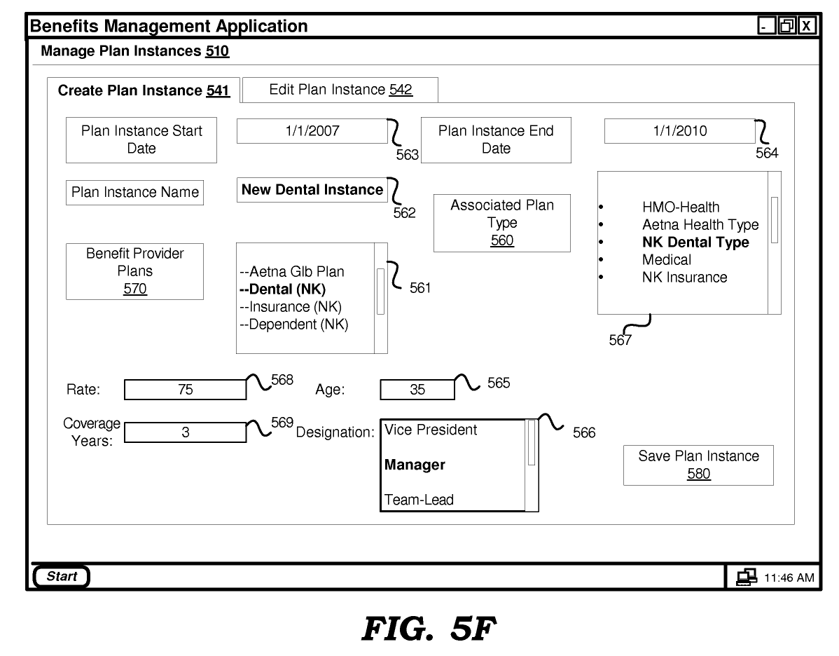

FIG. 5A depicts a screen provided to the benefits administrator to manage the benefits configuration. The screen is accessed by selecting Advanced Configuration 460/470 of FIGS. 4A/4B. Manage Configuration 500 represents a navigation panel that allows the benefits administrator to manage ‘Plan Instances’, ‘Plan Types’ and ‘Plan Groups’. The screen further contains ‘View Plan Type’, ‘View Plan Groups’ and ‘View Benefits Grouping’ tabs, which respectively allow the benefit administrator to view the current plan types, current plan groups and the current benefits grouping.

Selecting the ‘View Plan Type’ tab provides the benefits administrator 280 with a search plan type option. The benefits administrator 280 can search for a plan type by name or by effective date. The search results are displayed in the Search Results pane of the FIG. 5A.

FIG. 5B depicts the screen provided to the benefits administrator to View Plan Groups corresponding to ‘View Plan Group’ tab. The plan groups represent the specific groups already configured by the user as of the time of display. The benefits administrator 280 can search for a plan group by name or by effective date. The search results are displayed in the Search Results pane of the FIG. 5B.

FIG. 5C depicts the screen provided to the benefits administrator to manage benefits grouping by selecting the ‘Manage Benefits Grouping’ tab. As may be readily observed, several group names/identifiers are shown in benefits grouping area 531. The administrator may edit the name of each group and select or deselect of each group. Selection of a group makes the group available for associating the various plan instances, in addition to being displayed as a train stop as described in sections below. It may be noted that the groups in area 521 of FIG. 5B correspond to those selected in check 532. Selecting the corresponding box of view associated plan types 533 columns causes the previously associated plan types (described below) and the instances of the type, to be displayed.

It should be appreciated that the information in FIGS. 5A-5C corresponds to a time instance in which the plan instance configured in FIGS. 4C and 4C has not yet been integrated into a group. The manner in which the plan instance is integrated into a group is described below. Broadly, each plan instance is first specified as a part of a plan type, and the plan types in turn are associated with respective groups. Thus, once a plan type is associated with a group, instances merely need to be associated with the plan type to be associated with (or be part of) the group. However, alternative embodiments can be implemented in which a plan type is not used as an intermediary and a plan instance is directly associated with a group, as will be apparent to one skilled in the relevant arts by reading the disclosure provided herein.

FIG. 5D depicts a screen enabling a benefits administrator to manage plan instances. The screen may be accessed by selecting ‘manage plan instances’ in navigation panel 500. The user there is shown searching for plan instances having effective date of Jan. 1, 2007, and the results are shown in area 540. The user may create 541 plan instances as well using the screen. Area 540 is shown containing AETNA Instance, created earlier. Assuming the user selects that instance and selects edit 542, control is transferred to the screen of FIG. 5E.

FIG. 5E depicts the manner in which a user can associate a plan instance with a plan type. The user can edit the eligibility attributes, instance name, rate, etc, as shown. The user is shown associating the instance ‘AETNA INSTANCE’ to ‘AETNA HEALTH TYPE’. Though the instance is shown associated with a type identified with a provider, the types can be independent of such considerations.

FIG. 5F depicts the manner in which a benefits administrator 280 can create a plan instance and also associate the plan instance with a plan type. The screen may be accessed by selecting create button 541 of FIG. 5D. The benefits administrator is shown to have selected DENTAL (NK) from provider plans list 561, specified a name of ‘New Dental Instance’ at 562, specified the start and end dates at 563 and 564 respectively, specified the rate value 568 and coverage years 569, eligibility criteria (designation 565, age range 566) etc., in addition to associating the instance to NK dental type at 567. The changes are saved by selecting the save button. Control may then pass back to the screen of FIG. 5D.

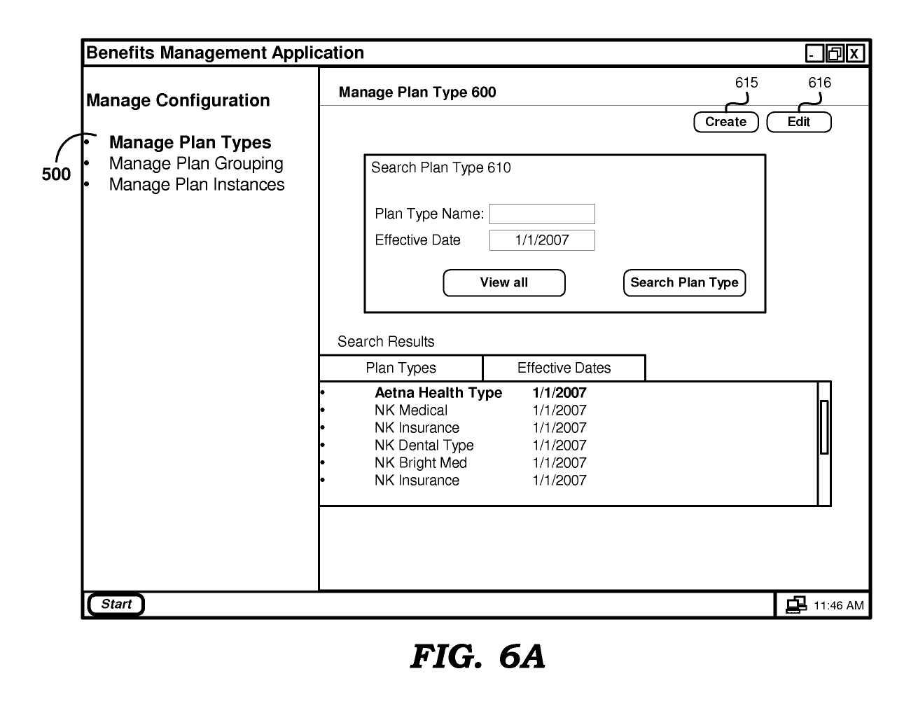

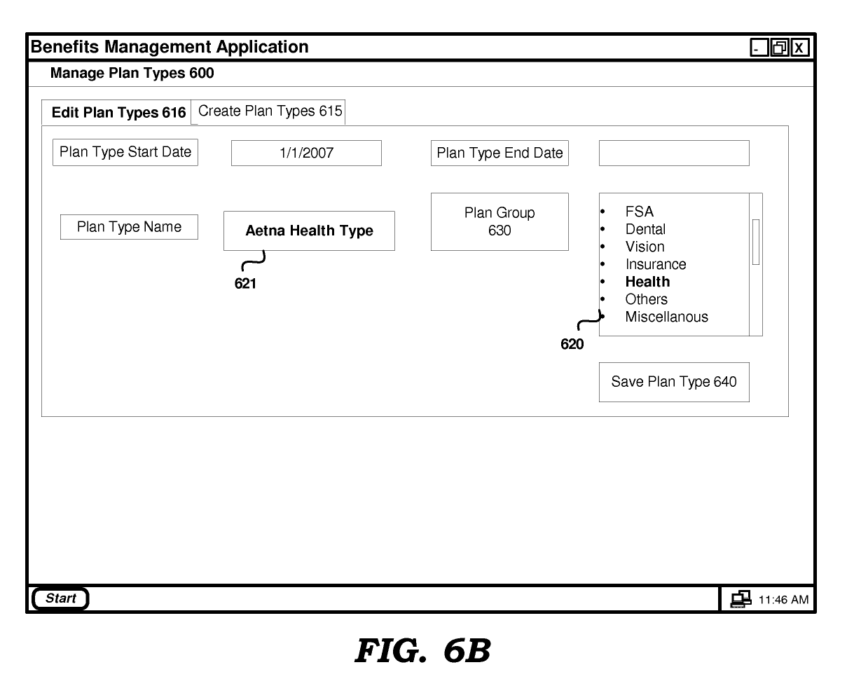

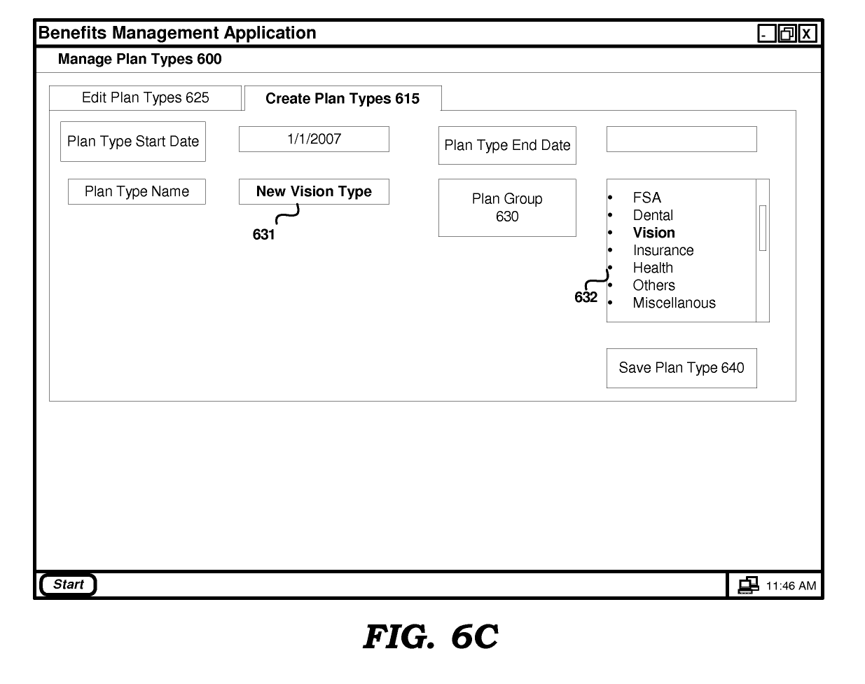

FIG. 6A depicts the manner in which a benefits administrator 280 may associate a plan type to a group. The screen may be accessed by selection of ‘manage plan types’ option of FIGS. 5A-5D. The user is shown to have searched for plan types having an effective date of Jan. 1, 2007 and the corresponding list displayed in area 610. The user is assumed to have selected ‘Aetna Health Type’ in area 610 and then selected edit 616, in which case control passes to the screen of FIG. 6B.

FIG. 6B depicts the manner in which a plan type is associated with a plan group. The groups previously defined are shown in area 620 and may be observed to match those shown selected at 532 of FIG. 5C. The benefits administrator 280 is assumed to associate the plan type of ‘AETNA HEALTH TYPE’ at 621 to ‘HEALTH’ group in list 620. Thus, the plan instance defined earlier is associated with HEALTH group by using AETNA HEALTH TYPE as an intermediary. The benefits administrator may also create a new plan type by selecting button 615 of FIG. 6A, in which case control passes to FIG. 6C.

FIG. 6C depicts the manner in which a plan type can be created and associated with a plan group. The user is shown having entered the new plan type's name as ‘NEW VISION TYPE’ (at 631) and associating it to plan group vision in area 632. The changes are saved by selecting the save button.

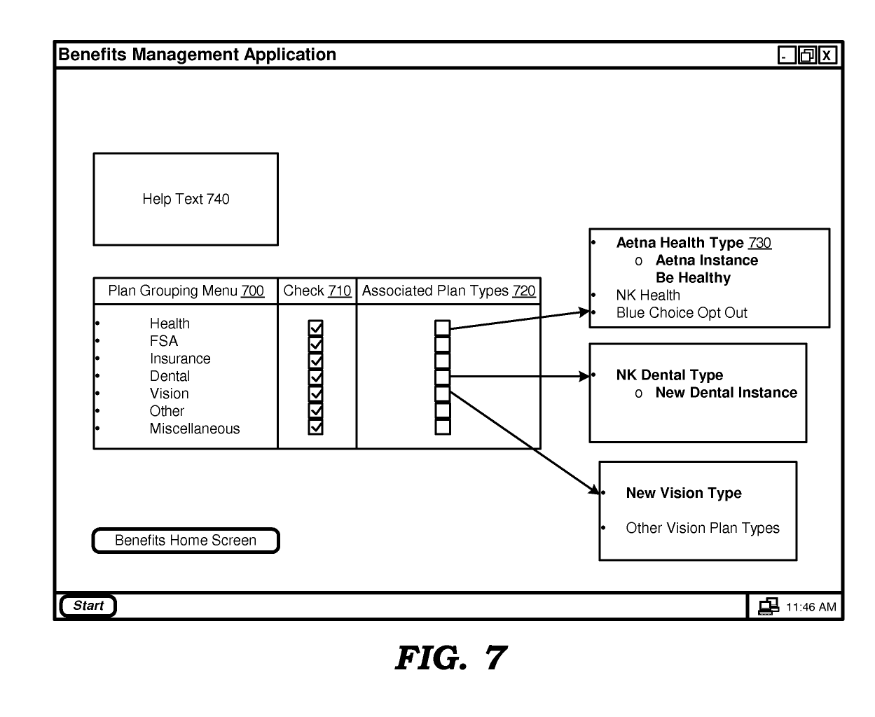

FIG. 7 depicts the manner in which the grouping information configured earlier can be viewed by a benefits administrator 280 (similar to in FIG. 5C). The benefits administrator 280 is shown viewing the details corresponding to health, dental and vision plan groups by selecting the corresponding box in column 720. As may be readily observed, AETNA INSTANCE is a part of AETNA HEALTH TYPE 730, which is grouped under health (consistent with the user inputs in FIGS. 4A-7). Similarly, NEW VISION TYPE is shown grouped under vision group.

Thus, once the benefits administrator 280 associates plan instances to specific groups, the users are provided user interface corresponding to such grouping when they enroll for the benefits of interest. In an embodiment, such user interface is in the form of a train stops, with each train stop corresponding to a group. The operation according to a train stop necessarily means that the navigation between groups is controlled such that the groups are according to a sequence and a group in the sequence can be accessed only from the previous member or the later member of the group. The train stops based user interface is described below in further detail.

### 5. Train Stops Based User Interface

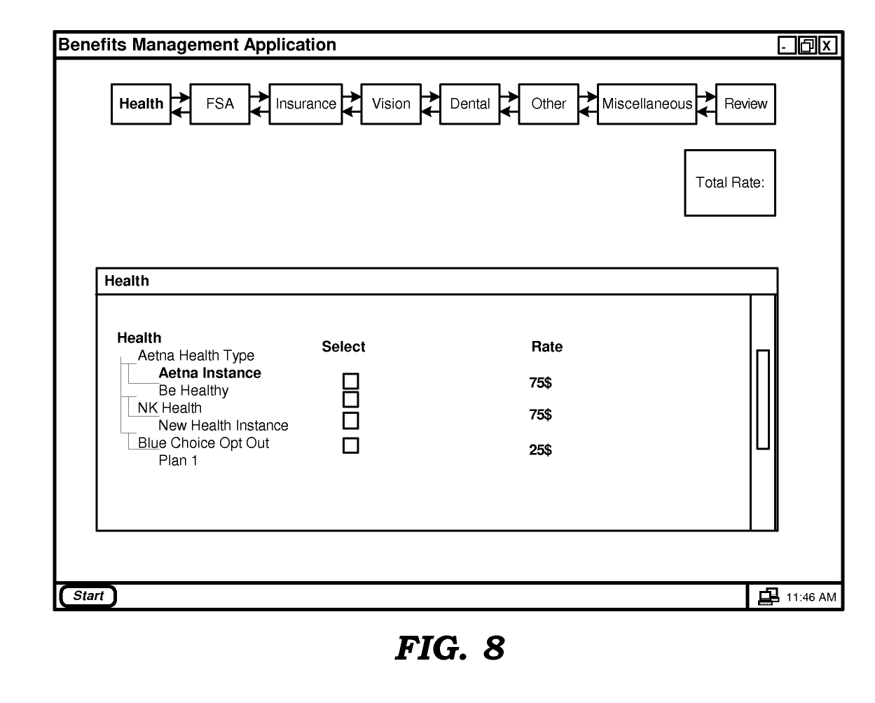

FIG. 8 depicts the user interface provided to an end user 235A-235D based on the configuration provided earlier by a benefits administrator in an embodiment. It is assumed that the information of FIG. 7 represents the state of configuration and that a specific end user has logged in (with proper authentication).

Customer server 120 determines the specific instances the end user is eligible to enroll in and displays only those of the enabled groups (in column 710) that have at least one eligible instance in train 810. In other words, if a group is not enabled in column 710, that group is not part of train 810. Similarly, even if a group is enabled in column 710, that group is not a stop in train 810 if there are no eligible instances in that group.

Train 810 is shown containing seven stops (same ones as those enabled in column 700 of FIG. 7) and a review stop. Each stop corresponds to one group. The arrows between successive groups represent the navigation constraints enforced by customer server 120. Thus, visions stop can be accessed in forward direction from only insurance group, and in backward direction from only dental group. When the navigation starts, the user may be initially provided option to process the information associated with the first group/stop (i.e., health). The stops thus represent a sequence that is to be followed in navigation across stops.

Display area 820 displays the plan types and instances within the group presently selected in train 810. Assuming the first stop health 810 is selected, the corresponding information is shown in display area 820. It should be appreciated that the display corresponds to the configuration of AETNA Instance as a part of AETNA health type (FIG. 5E) and the AETNA health type as a part of HEALTH group (FIG. 6B).

The user may select any of the desired plans shown in display area 820 to enroll for the specific instances, which are part of the presently selected group/stop. The user may then navigate to the next group in the order (forward or backward) for continuing with the enrolment process. From health group, the user may move to only FSA group if navigating the train. From FSA group, the user can either move to insurance group in the forward direction or back to health stop. Any previous selection action in a stop can be undone, or in general, selections changed.

Once the user reaches the last stop (review), customer server 120 displays all the plan instances selected and the total rate for such selections.

By having the train based approach (or enforcement of the sequence in navigation across groups) to enrolment, the end users may be systematically made to consider the instances in each group (due to the restrictions in navigation). Furthermore, by providing the benefits administrator to control the grouping of various instances, any logical grouping suited for specific environment, may be chosen by the benefits administrator for that environment. The benefits administrator 280 need not thus rely on developers/vendors for obtaining the desired grouping of various benefit instances.

It should be further appreciated that the administrator may also change the name/label of any of the train stops of FIG. 8. For example, assuming that the name of train stop ‘Dental’ is sought to be changed to ‘New Dental’, the benefits administrator may edit the text ‘Dental’ in FIG. 7 to ‘New Dental’. Once such a change is made by the benefits administrator, the changed label would be displayed to all the employees (in FIG. 8). Accordingly, all employees may see the changed label while enrolling in benefits thereafter.

It should be appreciated that the features described above can be implemented in various embodiments as a desired combination of one or more of hardware, executable modules, and firmware. The description is continued with respect to an embodiment in which various features are operative when executable modules are executed.

### 6. Digital Processing System

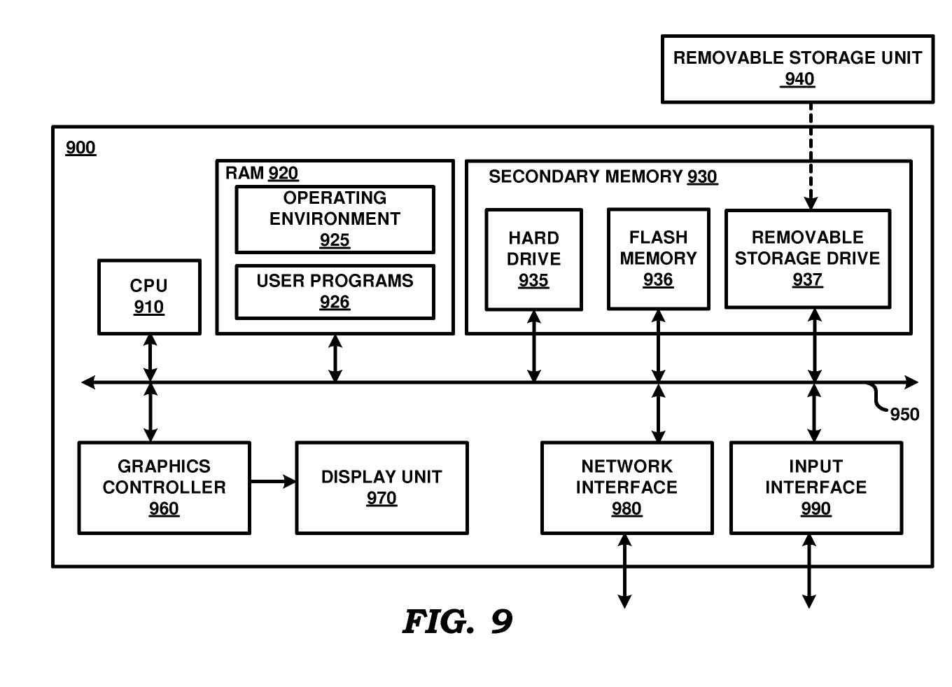

FIG. 9 is a block diagram illustrating the details of digital processing system 900 in which various aspects of the present invention are operative by execution of appropriate executable modules. Digital processing system 900 may correspond to customer server 120.

Digital processing system 900 may contain one or more processors such as a central processing unit (CPU) 910, random access memory (RAM) 920, secondary memory 930, graphics controller 960, display unit 970, network interface 980, and input interface 990. All the components except display unit 970 may communicate with each other over communication path 950, which may contain several buses as is well known in the relevant arts. The components of FIG. 9 are described below in further detail.

CPU 910 may execute instructions stored in RAM 920 to provide several features of the present invention. CPU 910 may contain multiple processing units, with each processing unit potentially being designed for a specific task. Alternatively, CPU 910 may contain only a single general-purpose processing unit.

RAM 920 may receive instructions from secondary memory 930 using communication path 950. RAM 920 is shown currently containing software instructions constituting operating environment 925 and/or other user programs 926 (such as the benefits management program in an enterprise, including the benefits enrolment features described above, etc.). In addition to operating environment 925, RAM 920 may contain other software programs such as device drivers, virtual machines, etc., which provide a (common) run time environment for execution of other/user programs.

Graphics controller 960 generates display signals (e.g., in RGB format) to display unit 970 based on data/instructions received from CPU 910. Display unit 970 contains a display screen to display the images defined by the display signals. Each of the displays shown in FIGS. 4A-8 corresponds to an image screen at corresponding time duration on the display screen. Input interface 990 may correspond to a keyboard and a pointing device (e.g., touch-pad, mouse) and may be used to provide inputs (such as those provided by the benefits administrator and end users as described above). Network interface 980 provides connectivity to a network (e.g., using Internet Protocol), and may be used to communicate with other systems connected to the network.

Secondary memory 930 may contain hard drive 935, flash memory 936, and removable storage drive 937. Secondary memory 930 may store the data (for example, various values shown entered/displayed in FIGS. 4B-8, etc.) and software instructions (which when executed by CPU 910, perform the steps of FIG. 2 and cause the states, including on the display screen, corresponding to that shown in FIGS. 4A-8), which enable digital processing system 900 to provide several features in accordance with the present invention.

Some or all of the data and instructions may be provided on removable storage unit 940, and the data and instructions may be read and provided by removable storage drive 937 to CPU 910. Floppy drive, magnetic tape drive, CD-ROM drive, DVD Drive, Flash memory, removable memory chip (PCMCIA Card, EPROM) are examples of such removable storage drive 937.

Removable storage unit 940 may be implemented using medium and storage format compatible with removable storage drive 937 such that removable storage drive 937 can read the data and instructions. Thus, removable storage unit 940 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 940 or hard disk installed in hard drive 935. These computer program products are means for providing software to digital processing system 900. CPU 910 may retrieve the software instructions, and execute the instructions to provide various features of the present invention described above.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the invention.

### 7. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of enrolling users in benefits offered by an enterprise, said method comprising:
enabling a benefits administrator to specify a plurality of plan instances and a set of groups, each plan instance being specified in one of said set of groups, said benefits administrator further specifying eligibility criteria for each of said plurality of plan instances;
receiving user data including attributes defining each user's eligibility for each plan instance;
identifying a set of plan instances a user is eligible for by comparing attributes in said user data with said eligibility criteria;
displaying said set of eligible instances according to the same groups specified by the administrator; and
facilitating said user to subscribe to plan instances of interest based on said displayed set of eligible instances.

2. The method of claim 1, wherein said facilitating comprises enforcing a sequence in which said groups are traversed such that each of said displayed set of groups represents a train stop in navigation of said groups.

3. The method of claim 2, wherein said displaying displays a group only if there is at least one eligible instance in the group identified by said identifying.

4. The method of claim 2, wherein said enabling comprises:
associating, by said benefits administrator, each of said plan instances with a corresponding one of a set of plan types such that multiple instances can be associated with each plan type; and
associating, by said benefits administrator, each of said set of plan types to one of said set of groups such that multiple plan types can be associated with each group.

5. The method of claim 4, wherein said enabling further enables said benefits administrator to specify a corresponding price plan associated with each plan instance,
wherein the corresponding price plan is displayed while said user subscribes to corresponding plan instance.

6. The method of claim 4, wherein said eligibility criteria comprises age range and designation of uses.

7. The method of claim 4, wherein said displaying displays each train stop with an associated name, said method comprising receiving text representing the name associated with a first train stop, wherein said displaying thereafter displays said received name for said first train stop during said navigation by said user.

8. A machine readable medium storing one or more sequences of instructions for causing a server to facilitate enrollment of user in benefits offered by an enterprise, wherein execution of said one or more sequences of instructions by one or more processors contained in said server causes said server to perform the actions of:
enabling a benefits administrator to specify a plurality of plan instances and a set of groups, each plan instance being specified in one of said set of groups, said benefits administrator further specifying eligibility criteria for each of said plurality of plan instances;
receiving user data including attributes defining each user's eligibility for each plan instance;
identifying a set of plan instances a user is eligible for by comparing attributes in said user data with said eligibility criteria;
displaying said set of eligible instances according to the same groups specified by the administrator; and
facilitating said user to subscribe to plan instances of interest based on said displayed set of eligible instances.

9. The machine readable medium of claim 8, wherein said facilitating comprises enforcing a sequence in which said groups are traversed such that each of said displayed set of groups represents a train stop in navigation of said groups.

10. The machine readable medium of claim 9, wherein said displaying displays a group only if there is at least one eligible instance in the group identified by said identifying.

11. The machine readable medium of claim 9, wherein said enabling comprises:
associating, by said benefits administrator, each of said plan instances with a corresponding one of a set of plan types such that multiple instances can be associated with each plan type; and
associating, by said benefits administrator, each of said set of plan types to one of said set of groups such that multiple plan types can be associated with each group.

12. The machine readable medium of claim 11, wherein said enabling further enables said benefits administrator to specify a corresponding price plan associated with each plan instance,
wherein the corresponding price plan is displayed while said user subscribes to corresponding plan instance.

13. The machine readable medium of claim 11, wherein said eligibility criteria comprises age range and designation of uses.

14. The machine readable medium of claim 11, wherein said displaying displays each train stop with an associated name, further comprising receiving text representing the name associated with a first train stop, wherein said displaying thereafter displays said received name for said first train stop during said navigation by said user.

15. A server to facilitate enrollment of user in benefits offered by an enterprise, said server comprising:
a memory to store a set of instructions;
a processor to retrieve and execute said instructions, wherein execution of said set of instructions causes said server to perform the actions of:
enabling a benefits administrator to specify a plurality of plan instances and a set of groups, each plan instance being specified in one of said set of groups, said benefits administrator further specifying eligibility criteria for each of said plurality of plan instances;
receiving user data including attributes defining each user's eligibility for each plan instance;
identifying a set of plan instances a user is eligible for by comparing attributes in said user data with said eligibility criteria;
displaying said set of eligible instances according to the same groups specified by the administrator; and
facilitating said user to subscribe to plan instances of interest based on said displayed set of eligible instances.

16. The server of claim 15, wherein said facilitating comprises enforcing a sequence in which said groups are traversed such that each of said displayed set of groups represents a train stop in navigation of said groups.

17. The server of claim 16, wherein said displaying displays a group only if there is at least one eligible instance in the group identified by said identifying.

18. The server of claim 16, wherein said enabling comprises:
associating, by said benefits administrator, each of said plan instances with a corresponding one of a set of plan types such that multiple instances can be associated with each plan type; and
associating, by said benefits administrator, each of said set of plan types to one of said set of groups such that multiple plan types can be associated with each group.

19. The server of claim 18, wherein said enabling further enables said benefits administrator to specify a corresponding price plan associated with each plan instance,
wherein the corresponding price plan is displayed while said user subscribes to corresponding plan instance.

20. The server of claim 19, wherein said eligibility criteria comprises age range and designation of uses.
